(19) United States
(12) Patent Application Publication
(10) Pub. No.: US 2025/0184712 A1
(43) Pub. Date: Jun. 5, 2025

(54) COMMUNICATION APPARATUS AND COMMUNICATION METHOD

(71) Applicant: Sony Group Corporation, Tokyo (JP)

(72) Inventor: Yoshiaki NAKA, Tokyo (JP)

(73) Assignee: Sony Group Corporation, Tokyo (JP)

(21) Appl. No.: 18/839,039

(22) PCT Filed: May 2, 2023
(86) PCT No.: PCT/JP2023/017105

§ 371 Date: Aug. 16, 2024

(30) Foreign Application Priority Data
May 25, 2022 (JP) 2022-085190

(51) Int. Cl. H04W 8/18; H04M 15/00

(52) U.S. Cl. CPC H04W 8/183; H04M 15/88

(57) ABSTRACT

A communication apparatus comprises circuitry configured to determine whether an end condition is satisfied, the end condition relating to an embedded subscriber identity module (eSIM) profile stored in a memory; and in a case that the end condition is satisfied, control display of an output via a user interface, the output requesting instruction whether or not to delete the eSIM profile.

### TECHNICAL FIELD

The present disclosure relates to a communication apparatus and a communication method.

### BACKGROUND ART

In many cases, a communication apparatus such as a smartphone can use predetermined wireless communication (e.g., cellular network) by inserting a subscriber identity module (SIM) card in which information regarding wireless communication (e.g., contractor information) is recorded into the communication apparatus. In recent years, communication apparatuses compatible with embedded SIM (eSIM) have been spreading as remote SIM provisioning (RSP) compatible communication apparatuses.

### CITATION LIST

### Non Patent Literature

NPL 1: SGP.21 V2.4, “RSP Architecture”, GSM Association, 3 Aug. 2021

### SUMMARY OF INVENTION

### Technical Problem

In an RSP-compatible communication apparatus, information regarding wireless communication (hereinafter referred to as a profile) can be rewritten without replacing the SIM card. This profile can be downloaded from a server on a network. Therefore, it is assumed that the spread of the RSP leads to an increase in the use of temporary wireless communication with a limited location and/or period.

While the RSP improves convenience of the communication apparatus, the RSP may also make the communication apparatus inconvenient. For example, since a plurality of profiles can be stored in the communication apparatus, a profile that is no longer necessary may continue to remain in the communication apparatus.

Therefore, the present disclosure proposes a highly convenient communication apparatus and communication method.

Note that the above problem or object is merely one of a plurality of problems or objects that can be solved or achieved by the plurality of embodiments disclosed in the present specification.

### Solution to Problem

In order to solve the above problem, a communication apparatus according to one embodiment of the present disclosure comprises circuitry configured to determine whether an end condition is satisfied, the end condition relating to an embedded subscriber identity module (eSIM) profile stored in a memory; and in a case that the end condition is satisfied, control display of an output via a user interface, the output requesting instruction whether or not to delete the eSIM profile.

### BRIEF DESCRIPTION OF DRAWINGS

FIG. 1 is a diagram illustrating a state in which a plurality of profiles remain in a terminal device.

FIG. 2 is a diagram illustrating a configuration example of a communication system according to an embodiment of the present disclosure.

FIG. 3 is a diagram illustrating a configuration example of a server according to the embodiment of the present disclosure.

FIG. 4 is a diagram illustrating a configuration example of a terminal device according to the embodiment of the present disclosure.

FIG. 5 is a diagram illustrating an example of an RSP architecture configuration applied to the communication system of the present embodiment.

FIG. 6 is a flowchart illustrating an example of an end condition setting process.

FIG. 7 is a diagram illustrating an example of a user interface for guiding to a list screen of installed profiles.

FIG. 8 is a diagram illustrating an example of a user interface for inquiring about whether or not to set the end condition.

FIG. 9 is a diagram illustrating an example of a user interface for setting the end condition.

FIG. 10 is a diagram illustrating an example of a user interface for notifying the user of the end condition.

FIG. 11 is a flowchart illustrating an example of a profile management process.

FIG. 12 is a diagram illustrating an example of a user interface for inquiring about deletion of a profile to the user.

FIG. 13 is a diagram illustrating another example of the user interface for inquiring about deletion of the profile to the user.

FIG. 14 is a diagram illustrating another example of the user interface for inquiring about deletion of the profile to the user.

FIG. 15 is a diagram illustrating another example of the user interface for inquiring about deletion of the profile to the user.

FIG. 16 is a diagram illustrating another example of the user interface for inquiring about deletion of the profile to the user.

FIG. 17 is a diagram illustrating another example of the user interface for inquiring about deletion of the profile to the user.

FIG. 18 is a table illustrating profile metadata requirements to be added.

FIG. 19 is a table illustrating local profile assistant (LPA) requirements to be added.

### DESCRIPTION OF EMBODIMENTS

Hereinafter, embodiments of the present invention are described in detail below with reference to the accompanying drawings. In each of the following embodiments, same parts are given the same reference signs to omit redundant description.

In addition, in the present specification and the drawings, a plurality of components having substantially the same functional configuration may be distinguished by attaching different numerals after the same reference sign. For example, a plurality of configurations having substantially the same functional configuration is distinguished as terminal devices 20₁ and 20₂ as necessary. However, when it is not particularly necessary to distinguish each of the plurality of components having substantially the same functional configuration, only the same reference sign is given. For example, when it is not necessary to particularly distinguish the terminal devices 20₁ and 20₂, they are simply referred to as a terminal device 20.

In the following description, one or a plurality of embodiments (including examples and modifications) may be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### <<1. Overview>>

Terminal devices compatible with remote SIM provisioning (RSP) have been spreading. For example, in recent years, terminal devices compatible with an embedded SIM (eSIM) have become widespread. The RSP-compatible terminal device can rewrite information regarding wireless communication (hereinafter referred to as a profile) without replacing a SIM card.

Here, the profile is information regarding wireless communication, and is data in which service provider (carrier) information and contractor information (e.g., ICCID assigned to eSIM) are recorded. An IC card identifier (ICCID) is a unique number for identifying the profile.

The profile may be an eSIM profile. The eSIM profile is a profile used in an eSIM-compatible communication apparatus. For example, the eSIM profile is a combination of data and applications to be provisioned on an eUICC for the purpose of providing services. The Embedded UICC (eUICC) is a universal integrated circuit card (UICC) that enables local management of the profile in a secure manner. In the following description, the eSIM profile may be simply referred to as the profile.

This profile can be downloaded from a server on a network. Therefore, it is assumed that the spread of the RSP leads to an increase in the use of temporary wireless communication with a limited location and/or period. While the RSP improves convenience of the communication apparatus, the RSP may also make the communication apparatus inconvenient. For example, since a plurality of profiles can be stored in the terminal device, an unnecessary profile may continue to remain in the communication apparatus.

For example, it is assumed that a two-dimensional code (e.g., QR code (registered trademark)) of the eSIM profile that enables the use of local 5G at an event venue is delivered from an event organizer, and a user downloads the eSIM profile to his/her terminal device using the two-dimensional code. Since the local 5G cannot be used outside the event venue, the downloaded eSIM profile will be unnecessary when the user exits the event venue. However, when the user does not delete the eSIM profile, the eSIM profile continues to remain in the terminal device.

Still more, it is assumed that the eSIM profile enabling wireless communication of a predetermined data amount is distributed via a magazine appendix, a website, or the like, and the user downloads the eSIM profile to his/her terminal device. Once the predetermined data amount is used, the downloaded eSIM profile will be unnecessary. However, also in this case, when the user does not delete this eSIM profile, the eSIM profile continues to remain in the terminal device.

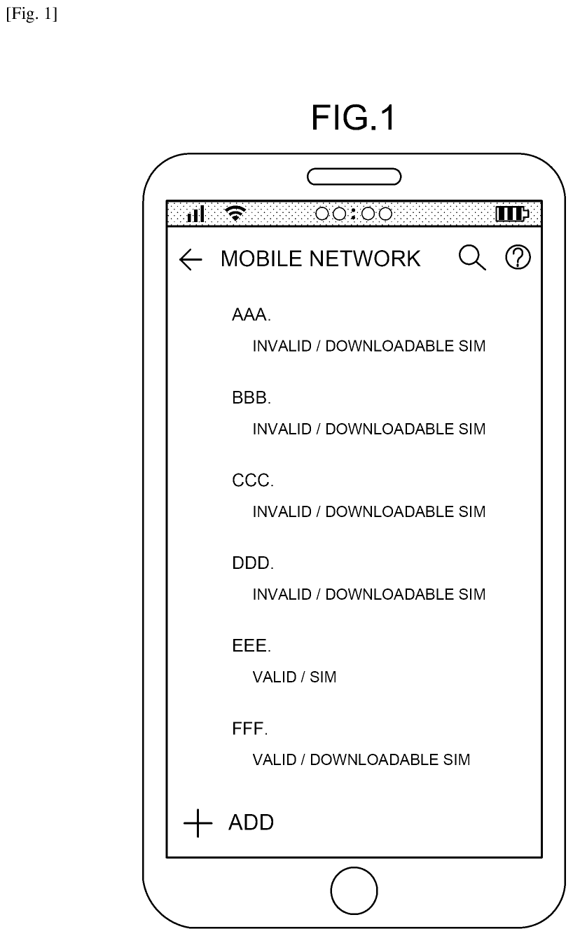

FIG. 1 is a diagram illustrating a state in which a plurality of profiles remain in the terminal device. In an example in FIG. 1, the plurality of profiles stored in the terminal device, a profile state (valid/invalid) and a profile type (downloadable SIM (e.g., eSIM)/SIM) of each profile are displayed via a display provided in the terminal device. Each of AAA., BBB., CCC., DDD., EEE., and FFF. indicates the profile. The profile state and type are displayed immediately below each profile in association with each other. Here, “invalid” of the profile state indicates that a corresponding profile is not validated (not currently used) in the terminal device. In addition, “valid” of the profile state indicates that the corresponding profile is validated (currently used) in the terminal device. In other words, “valid” and “invalid” of the profile state are not directly related to whether or not there is a current line contract with an operator corresponding to the profile. Therefore, in the example in FIG. 1, the profile AAA, the profile BBB, and the profile CCC in which the profile state is “invalid” continue to remain in the terminal device even though at least one of the profile AAA, the profile BBB, and the profile CCC may be already in an unavailable state (e.g., data communication cannot be performed) due to, for example, an expiration of a contract or a failure to satisfy terms of use. The fact that the unused profile continues to remain in the terminal device may cause inconvenience to the user, such as a possibility of failing to download a next profile.

Therefore, the present embodiment solves the above problem as follows.

The terminal device of the present embodiment has a function related to storage and deletion of the profile regarding wireless communication. For example, the terminal device of the present embodiment is provided with an LPA for managing the eSIM profile. The LPA has a function of recording the plurality of profiles in the terminal device (e.g., memory in eUICC).

The terminal device of the present embodiment is configured to determine whether or not an end condition of the use of the profile is satisfied. The end condition may include at least one of reaching an expiration date set in the profile, exiting a service area set in the profile, reaching data usage limit set in the profile, and continuing a state that the profile is not used for a predetermined period. When it is determined that the end condition is satisfied, the terminal device executes an inquiry about deletion of the profile to the user via a user interface. When a response indicating deletion of the profile is acquired from the user, the terminal device deletes the profile.

This facilitates profile management, thereby improving convenience of the terminal device.

For example, by giving the user an opportunity to delete the profile that is not valid or is not used effectively, it is possible to prompt the user to transfer the profile to another eSIM-compatible device or cancel an unnecessary profile. Deletion of the profile that is not used is also desirable from a perspective of effectively using a limited number of ICCIDs.

In addition, it is possible to increase the size of free memory in the eUICC by giving the user an opportunity to delete the profile that is not valid or not used effectively.

The overview of the present embodiment has been described above, and hereinafter, a communication system 1 according to the present embodiment will be described in detail.

### <<2. Configuration of Communication System>>

First, a configuration of the communication system 1 will be described.

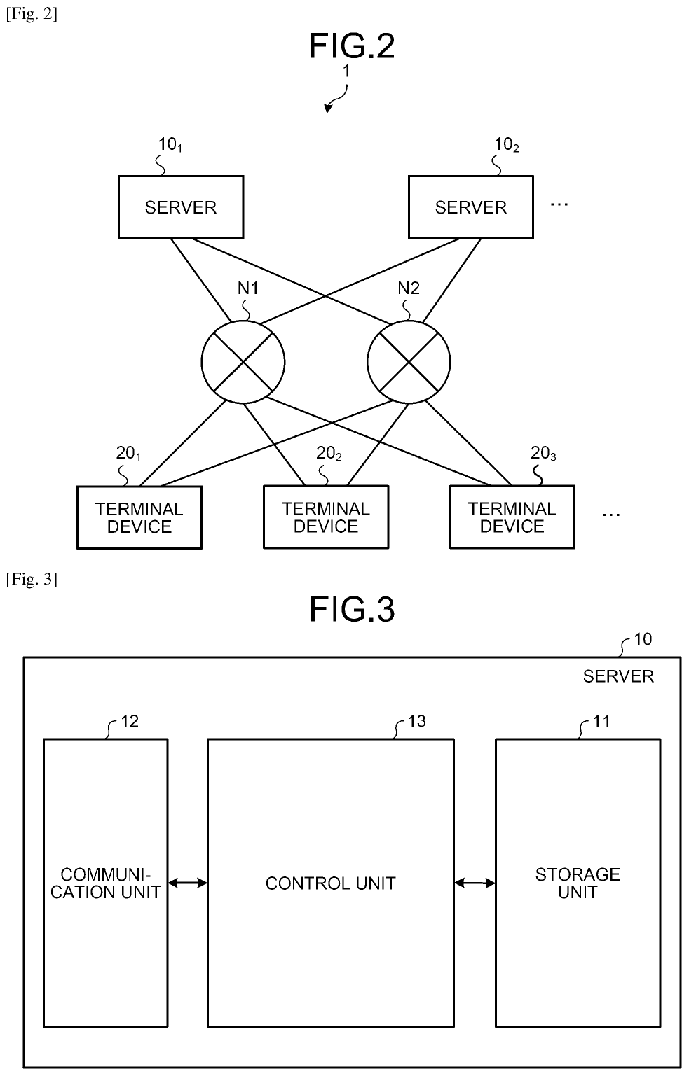

FIG. 2 is a diagram illustrating a configuration example of the communication system 1 according to the embodiment of the present disclosure. The communication system 1 includes a server 10 and a terminal device 20. The communication system 1 may include a plurality of servers 10 and a plurality of terminal devices 20. In the example in FIG. 2, the communication system 1 includes servers 10₁, 10₂, and the like as the server 10, and includes terminal devices 20₁, 20₂, 20₃, and the like as the terminal device 20. The terminal device 20 may be configured to be connectable to a plurality of networks. In the example in FIG. 2, the terminal device 20 is configured to be connectable to a network N1 and a network N2. The terminal device 20 is connected to the server 10 via the network N1 or the network N2.

The networks N1 and N2 are, for example, communication networks such as a local area network (LAN), a wide area network (WAN), a cellular network, a fixed telephone network, a regional Internet protocol (IP) network, and the Internet. The networks N1 and N2 may include a wired network or a wireless network. In addition, the networks N1 and N2 may include a core network. The core network is, for example, an evolved packet core (EPC) or a 5G core network (5GC). Naturally, a network N may be a data network connected to the core network. The data network may also be a service network of a telecommunications carrier such as an IP multimedia subsystem (IMS) network. Furthermore, the data network may be a private network such as an intra-company network.

Although only two networks are illustrated in the example in FIG. 2, the number of networks is not limited to two. For example, networks to which the terminal device 20 can be connected may be a plurality of cellular networks with different communication carriers and a wireless LAN network (e.g., Wi-Fi (registered trademark)).

The terminal device 20 may be connectable to the network using a plurality of communication paths. In this case, at least one of the plurality of communication paths may be a wireless communication path. For example, the communication path may be a wireless communication path (radio access network) between the terminal device 20 and a base station. Furthermore, the communication path may be a wireless communication path between the terminal device 20 and an access point. Naturally, the plurality of communication paths may include a wired communication path (e.g., wired LAN). Note that the communication path may be a network itself.

When the wireless communication path is included in the plurality of communication paths, the terminal device 20 may be configured to connect to a network using a radio access technology (RAT) such as long term evolution (LTE), new radio (NR), Wi-Fi, and Bluetooth (registered trademark). In this case, the terminal device 20 may be configured to be able to use different radio access technologies (wireless communication systems). For example, the terminal device 20 may be configured to be able to use the NR and the Wi-Fi. Furthermore, the terminal device 20 may be configured to be able to use different cellular communication technologies (e.g., LTE and NR). The LTE and NR are types of cellular communication technology, and enable mobile communication of a terminal device by arranging a plurality of cellular areas covered by the base station.

Note that, in the following description, the “LTE” includes LTE-Advanced (LTE-A), LTE-Advanced Pro (LTE-A Pro), and evolved universal terrestrial radio access (EUTRA). Still more, the NR includes new radio access technology (NRAT) and further EUTRA (FEUTRA). Note that a single base station may manage a plurality of cells. In the following description, a cell corresponding to LTE is referred to as an LTE cell, and a cell corresponding to NR is referred to as an NR cell.

The NR is the radio access technology of a next generation (fifth generation) of the LTE (fourth generation communication including LTE-Advanced and LTE-Advanced Pro). The NR is the radio access technology that can support various use cases including enhanced mobile broadband (eMBB), massive machine type communications (mMTC), and ultra-reliable and low latency communications (URLLC). The NR has been studied aiming at a technical framework corresponding to use scenarios, requirements, arrangement scenarios, and the like in these use cases.

Note that the terminal device 20 may be connectable to a network using the radio access technology (wireless communication system) other than LTE, NR, Wi-Fi, and Bluetooth. For example, the terminal device 20 may be connectable to a network by using low power wide area (LPWA) communication. Furthermore, the terminal device 20 may be connectable to a network using wireless communication of a unique standard.

Here, the LPWA communication is the wireless communication that enables low-power wide-area communication. For example, the LPWA radio is Internet of Things (IoT) wireless communication using a specified low power radio (e.g., 920 MHz band) or an industry-science-medical (ISM) band. Note that the LPWA communication used by the terminal device 20 may conform to the LPWA standard. Examples of the LPWA standard include ELTRES, ZETA, SIGFOX, LoRaWAN, and NB-Iot. It is apparent that the LPWA standards are not limited thereto, and may be other LPWA standards.

Note that the plurality of communication paths may include a virtual network. For example, the plurality of communication paths to which the terminal device 20 can be connected may include a virtual network such as a virtual local area network (VLAN) and a physical network such as an IP communication path. In this case, the terminal device 20 may perform route control based on a route control protocol such as open shortest path first (OSPF) or border gateway protocol (BGP).

In addition, the plurality of communication paths may include one or more overlay networks or one or more network slices.

Note that the devices in FIG. 2 may be considered as devices in a logical sense. Specifically, a part or all of the devices in FIG. 2 may be realized by a virtual machine (VM), a container, a docker, or the like, and they may be implemented on physically the same hardware.

Furthermore, in the present embodiment, the communication apparatus is a device having a communication function, and at least the terminal device 20 is the communication apparatus in the example in FIG. 2. The server 10 may also be regarded as the communication apparatus.

Hereinafter, a configuration of each device configuring the communication system 1 will be specifically described. Note that the configuration of each device described below is merely an example. The configuration of each device may be different from the following configuration.

### <2-1. Configuration of Server>

First, a configuration of the server 10 will be described.

The server 10 is an information processor (computer) that provides various services to the terminal device 20 via a network (e.g., networks N1 and N2). For example, the server 10 may be a server called a subscription manager-data preparation+ (SM-DP+) or a server called a subscription manager-discovery server (SM-DS). The SM-DP+ is the server that serves to transmit the profile to the terminal device 20. The SM-DS is the server that serves to provide one or more SM-DP+ addresses to the terminal device 20.

Note that the server 10 is not limited to the above servers (SM-DP+ and SM-DS). For example, the server 10 may be an application server or a web server. The server 10 may be a PC server, a midrange server, or a mainframe server. Furthermore, the server 10 may be an information processor that performs data processing (edge processing) near the user or the terminal. For example, the server 10 may be an information processor (computer) provided attached to or built in the base station. Naturally, the server 10 may also be an information processor that performs cloud computing.

FIG. 3 is a diagram illustrating a configuration example of the server 10 according to the embodiment of the present disclosure. The server 10 includes a storage unit 11, a communication unit 12, and a control unit 13. Note that the configuration illustrated in FIG. 3 is a functional configuration, and a hardware configuration may be different from the functional configuration. Furthermore, functions of the server 10 may be implemented in a distributed manner in a plurality of physically separated configurations. For example, the server 10 may include a plurality of information processors.

The storage unit 11 is a data readable/writable storage device such as a dynamic random access memory (DRAM), a static random access memory (SRAM), a flash memory, and a hard disk. The storage unit 11 functions as a storage means of the server 10. The storage unit 11 stores, for example, a prediction model (learning model) to be distributed to the terminal device 20, such as a quality prediction model and an intention prediction model. These pieces of information will be described later.

The communication unit 12 is a communication interface for communicating with other devices. For example, the communication unit 12 is a network interface. For example, the communication unit 12 is a local area network (LAN) interface such as a network interface card (NIC). Note that the communication unit 12 may be a wired interface or a wireless interface. The communication unit 12 functions as a communication means of the server 10. The communication unit 12 communicates with the terminal device 20 under the control of the control unit 13.

The control unit 13 is a controller that controls each unit of the server 10. The control unit 13 is realized by, for example, a processor such as a central processing unit (CPU) or a micro processing unit (MPU). For example, the control unit 13 is implemented by a processor executing various programs stored in a storage device inside the server 10 using a random access memory (RAM) or the like as a work area. Note that the control unit 13 may be realized by an integrated circuit such as an application specific integrated circuit (ASIC) or a field programmable gate array (FPGA). Any of the CPU, the MPU, the ASIC, and the FPGA can be regarded as the controller.

### <2-2. Configuration of Terminal Device>

Next, a configuration of the terminal device 20 will be described.

The terminal device 20 is the communication apparatus that communicates with other communication apparatuses such as the base station and the access point. The terminal device 20 is configured to be connectable to the plurality of communication paths. For example, the terminal device 20 may be configured to be connectable to two communication paths of the Wi-Fi (registered trademark) and the cellular network.

Any form of computer can be employed as the terminal device 20. For example, the terminal device 20 may be a mobile terminal such as a mobile phone, a smart device (smartphone or tablet), a personal digital assistant (PDA), or a notebook PC. Still more, the terminal device 20 may be a wearable device such as a smart watch. Still more, the terminal device 20 may be an xR device such as an augmented reality (AR) device, a virtual reality (VR) device, and a mixed reality (MR) device. Still more, the terminal device 20 may be an imaging device (e.g., camcorder) having a communication function, or may be a motorcycle, a moving relay vehicle, or the like on which a communication apparatus such as a field pickup unit (FPU) is mounted. Furthermore, the terminal device 20 may be a machine to machine (M2M) device or an Internet of things (IoT) device. The terminal device 20 may be a router having the plurality of communication paths.

Furthermore, the terminal device 20 may be able to perform the LPWA communication with another communication apparatus (e.g., base station, access point, and another terminal device 20). Furthermore, the wireless communication used by the terminal device 20 may be wireless communication using millimeter waves. Note that the wireless communication used by the terminal device 20 may be wireless communication using radio waves or wireless communication using infrared rays or visible light (optical wireless communication).

Furthermore, the terminal device 20 may be a mobile device. The mobile device is a mobile wireless communication apparatus. In this case, the terminal device 20 may be a wireless communication apparatus installed in a moving body or may be the moving body itself. For example, the terminal device 20 may be a vehicle that moves on a road, such as an automobile, a bus, a truck, and a motorcycle, or the wireless communication apparatus mounted on the vehicle. Note that the moving body may be a mobile terminal, or may be a moving body that moves on land, in the ground, on water, or under water. Furthermore, the moving body may be a moving body that travels in the atmosphere, such as a drone and a helicopter, or may be a moving body that travels outside the atmosphere such as an artificial satellite.

The terminal device 20 may be simultaneously connected to a plurality of base stations or a plurality of cells to perform communication. For example, when one base station supports a communication area via the plurality of cells (e.g., pCell and sCell), it is possible to bundle the plurality of cells and communicate between the base station and the terminal device 20 by a carrier aggregation (CA) technology, a dual connectivity (DC) technology, or a multi-connectivity (MC) technology. Alternatively, the terminal device 20 and the plurality of base stations can communicate with each other by a coordinated multi-point transmission and reception (COMP) technology via cells of different base stations.

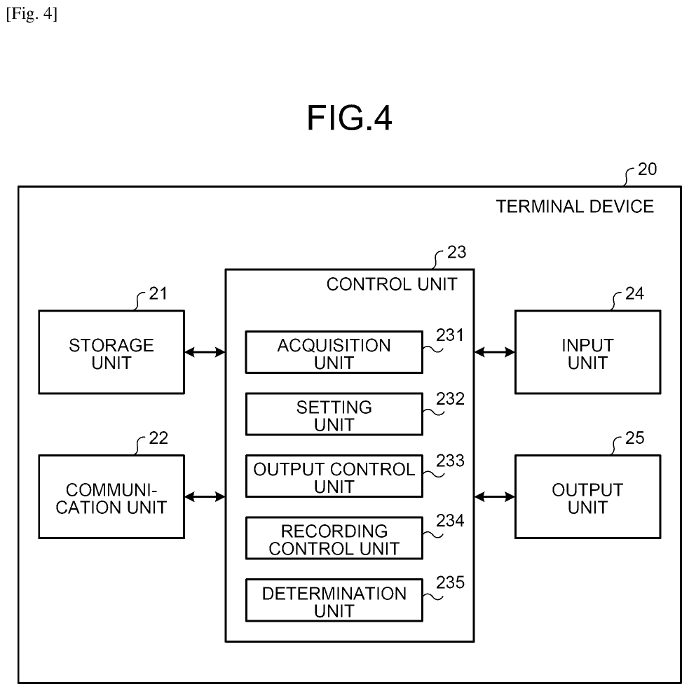

FIG. 4 is a diagram illustrating a configuration example of the terminal device 20 according to the embodiment of the present disclosure. The terminal device 20 includes a storage unit 21, a communication unit 22, a control unit 23, an input unit 24, and an output unit 25. Note that the configuration illustrated in FIG. 4 is a functional configuration, and a hardware configuration may be different from the functional configuration. Furthermore, functions of the terminal device 20 may be implemented in a distributed manner in a plurality of physically separated configurations.

The storage unit 21 is a storage device capable of reading and writing data, such as a DRAM, an SRAM, a flash memory, and a hard disk. The storage unit 21 may be a memory in the eUICC. The storage unit 21 functions as a storage means of the terminal device 20. The storage unit 21 stores, for example, the profile that has been downloaded. The plurality of profiles can be recorded in the storage unit 21.

The communication unit 22 is a communication interface for connecting to the network. The communication unit 22 may be a wireless interface or a wired interface. When the communication unit 22 is the wireless interface, the communication unit 22 may support a plurality of radio access technologies (wireless communication methods). For example, the communication unit 22 may be compatible with LTE, NR, or Wi-Fi. In addition, the communication unit 22 may support the radio access technology such as Bluetooth or LPWA. Furthermore, when the communication unit 22 is the wired interface, the communication unit 22 may be the LAN interface such as the NIC.

The control unit 23 is a controller that controls each unit of the terminal device 20. The control unit 23 is realized by, for example, a processor such as the CPU or an MPU. For example, the control unit 23 is realized by a processor executing various programs stored in a storage device inside the terminal device 20 using a RAM or the like as a work area. Note that the control unit 23 may be realized by an integrated circuit such as an ASIC or an FPGA. Any of the CPU, the MPU, the ASIC, and the FPGA can be regarded as the controller. Furthermore, the control unit 23 may be realized by a GPU in addition to or instead of the CPU.

The control unit 23 includes an acquisition unit 231, a setting unit 232, an output control unit 233, a recording control unit 234, and a determination unit 235. Each block (acquisition unit 231 to determination unit 235) configuring the control unit 23 is a functional block indicating a function of the control unit 23. These functional blocks may be software blocks or hardware blocks. For example, each of the functional blocks described above may be one software module realized by software (including mi-croprogram), or may be one circuit block on a semiconductor chip (die). It is apparent that each functional block may be one processor or one integrated circuit. Note that the control unit 23 may be configured by a functional unit different from the above-described functional blocks. A configuration method of the functional blocks is arbitrary.

Note that the control unit 23 may be an embedded UICC (eUICC). In this case, the eUICC may be mounted on a substrate in the terminal device 20, or may be mounted on a card inserted into the terminal device 20. Furthermore, each block (acquisition unit 231 to determination unit 235) configuring the control unit 23 may be a functional element included in an LPA.

The input unit 24 is an input device that receives various inputs from outside. For example, the input unit 24 is an operation device for the user to perform various operations, such as a keyboard, a mouse, and an operation key. Note that, when a touch panel is adopted as the terminal device 20, the touch panel is also included in the input unit 24. In this case, the user performs various operations by touching a screen with a finger or a stylus.

The output unit 25 is a device that performs various outputs such as sound, light, vibration, and an image to outside. The output unit 25 performs various outputs to the user under the control of the control unit 23. Note that the output unit 25 includes a display device that displays various types of information. The display device is, for example, a liquid crystal display or an organic electro luminescence (EL) display. Note that the output unit 25 may be a touch panel type display device. In this case, the input unit 24 and the output unit 25 may be regarded as an integrated configuration.

### <2-3. RSP Architecture>

Next, a remote SIM provisioning (RSP) architecture will be described.

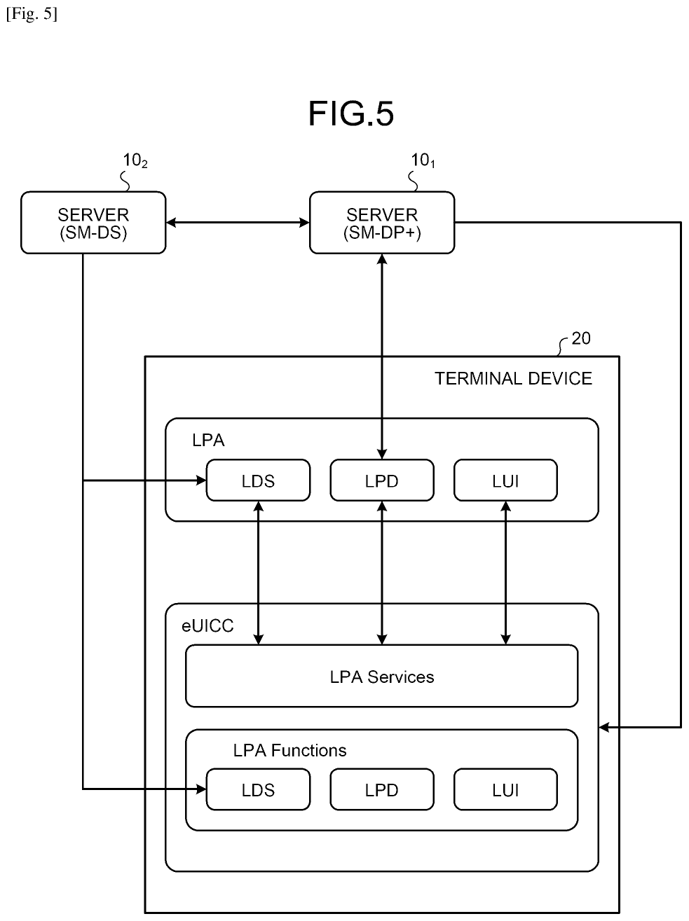

FIG. 5 is a diagram illustrating a configuration example of the RSP architecture applied to the communication system 1 according to the present embodiment. The RSP architecture illustrated in FIG. 5 includes the server 10₁ (SM-DP+), the server 10₂ (SM-DS), and the terminal device 20.

The server 10₁ is a server called subscription manager-data preparation+ (SM-DP+). The SM-DP+ sends the profile to the LPA of the eUICC of the terminal device 20.

The server 10₂ is a server called the subscription manager-discovery server (SM-DS). The SM-DS provides one or more addresses of SM-DP+ to a local discovery service (LDS) of the terminal device 20.

The terminal device 20 is user equipment used in combination with the eUICC. The terminal device 20 includes the LPA and the eUICC.

The LPA is a functional element (software) that provides an local profile download (LPD) function, the LDS function, and a local user interface (LUI) function. The LPA may be a functional element in the terminal device 20, or may be a functional element in the eUICC.

The Embedded UICC (eUICC) is a universal integrated circuit card (UICC) that enables local management of the profile in a secure manner. The eUICC may be mounted on a substrate in the terminal device 20, or may be mounted on a card inserted into the terminal device 20. The eUICC includes an LPA service and the LPA.

The LPA service is a functional element (software) that provides necessary services for the LPA function and necessary access to data. For example, the LPA is a functional element (software) that provides the LPD function, the LDS function, and the LUI function. The LPA has a function of recording a plurality of profiles in the memory in the eUICC.

### <<3. Operation of Communication System>>

The configuration of the communication system 1 has been described above. Next, the operation of the communication system 1 having the above configuration will be described. The operation of the communication system 1 is divided into an end condition setting process and a profile management process.

### <3-1. End Condition Setting Process>

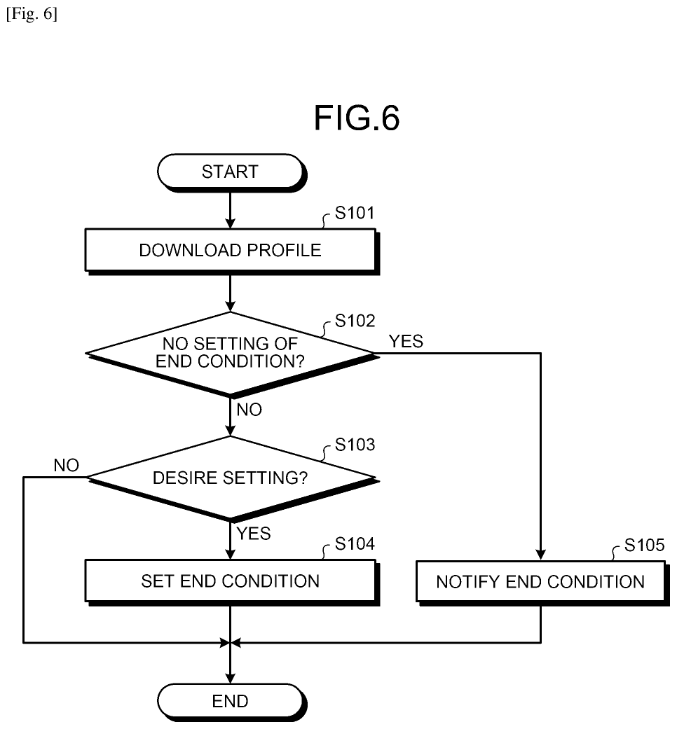

First, the end condition setting process will be described. The end condition setting process is a process for setting the end condition in the profile when the end condition of the use is not set in the profile. FIG. 6 is an example of a flowchart illustrating the end condition setting process. The following process is executed, for example, by the control unit 23 of the terminal device 20. The end condition setting process will be described below with reference to the flowchart in FIG. 6.

First, the acquisition unit 231 of the terminal device 20 downloads the profile from the server 10 (Step S101). Then, the terminal device 20 stores the downloaded profile in the storage unit 21 (e.g., memory in eUICC).

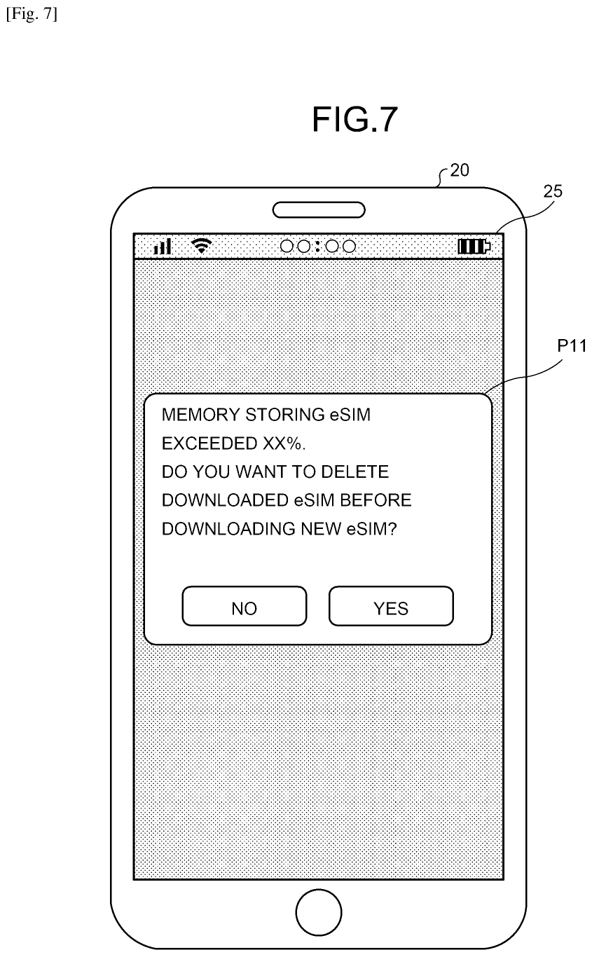

Note that the terminal device 20 may check the memory usage before newly downloading the profile to the eUICC. Then, when the memory usage exceeds a predetermined amount, the terminal device 20 may guide the user to a list screen of installed profiles via the user interface. FIG. 7 is a diagram illustrating an example of the user interface for guiding to the list screen of installed profiles. In the example in FIG. 7, a pop-up window (hereinafter simply referred to as a window.) is illustrated as the user interface, but the user interface is not limited to the pop-up window. In the example in FIG. 7, the terminal device 20 displays, on the output unit 25, a window P11 for guiding the user to the list screen of installed profiles. In the drawing, a number indicating a current usage rate of the memory is displayed as XX. In addition, in the drawing, eSIM indicates the eSIM profile.

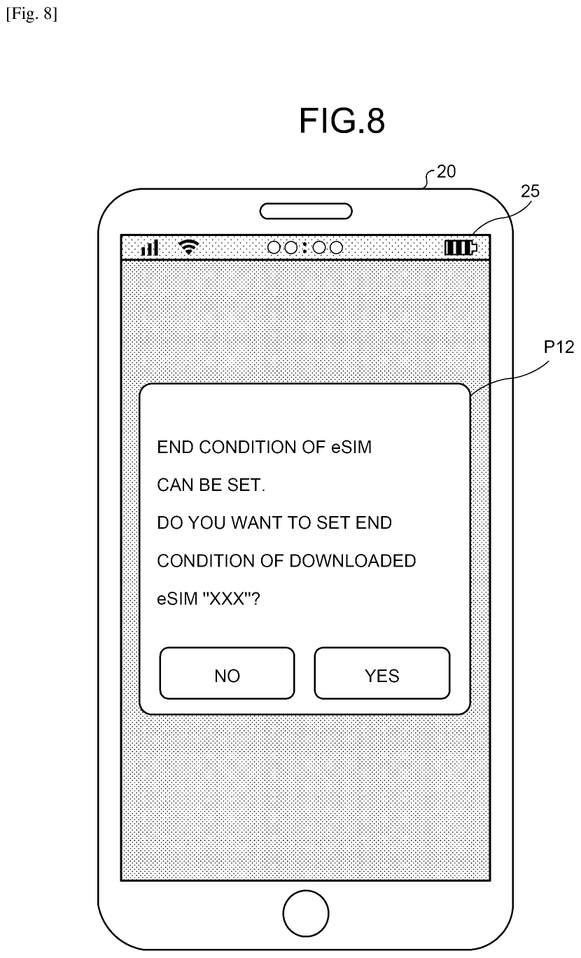

Returning to FIG. 6, the setting unit 232 of the terminal device 20 determines whether the end condition of the use is set in the downloaded profile (Step S102). When the end condition is not set (Step S102: No), the terminal device 20 inquires of the user whether or not to set the end condition in the profile via the user interface. FIG. 8 is a diagram illustrating an example of the user interface for inquiring about whether or not to set the end condition. In the example in FIG. 8, the terminal device 20 displays, on the output unit 25, a window P12 for inquiring of the user whether or not to set the end condition of the use of the profile. In the drawing, a character string for identifying the downloaded profile is indicated as XXX.

Returning to FIG. 6, when the user gives a response indicating that the setting of the end condition is not desired (Step S103: No), the terminal device 20 ends the end condition setting process. When the user gives a response indicating that setting of the end condition is desired (Step S103: Yes), the terminal device 20 sets the end condition of the use in the profile (Step S104).

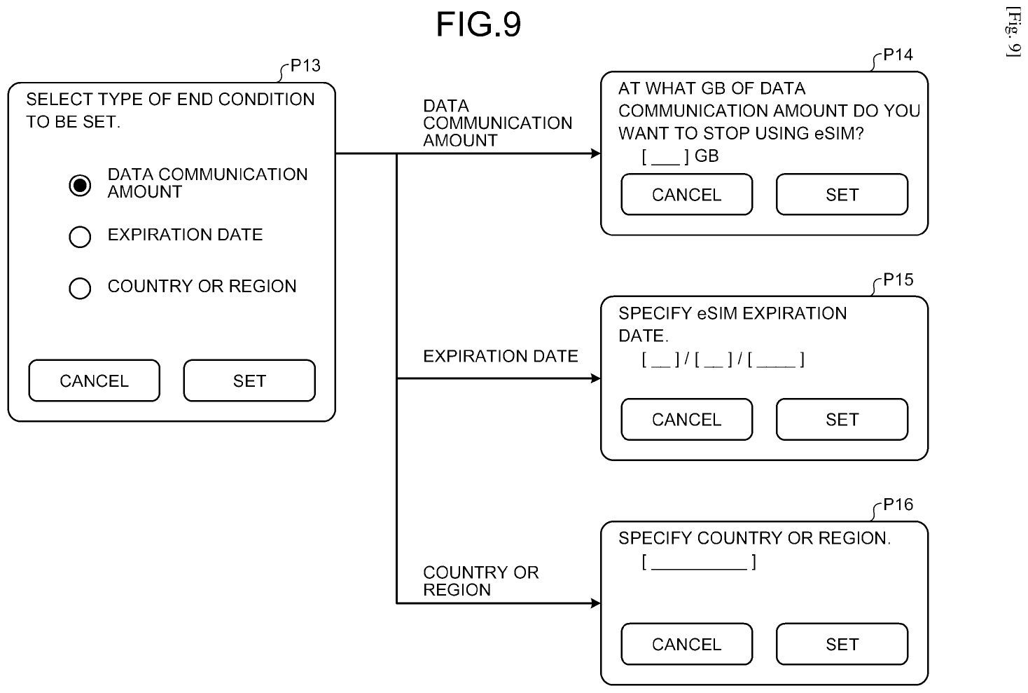

FIG. 9 is a diagram illustrating an example of the user interface for setting the end condition. In FIG. 9, only windows displayed on the output unit 25 of the terminal device 20 are illustrated, and illustration of the terminal device 20 is omitted. In the example in FIG. 9, the terminal device 20 is configured to set the following three (A1) to (A3) as the end condition.
(A1) Data communication amount
(A2) Expiration date
(A3) Available area (e.g., country or region)

First, the output control unit 233 of the terminal device 20 inquires of the user which one of (A1) to (A3) is to be set via the user interface. For example, the terminal device 20 displays, on the output unit 25, a window P13 for inquiring of the user which one of (A1) to (A3) is to be set. Then, the terminal device 20 displays the user interface for setting the end condition according to user selection.

For example, when the user desires to set (A1) Data communication amount, the terminal device 20 displays, on the output unit 25, a window P14 for setting the data communication amount as the end condition. The data communication amount (data usage limit) set here is an upper usage limit of communication based on the profile.

Furthermore, when the user desires to set (A2) Expiration date, the terminal device 20 displays, on the output unit 25, a window P15 for setting the expiration date as the end condition. The expiration date set here is an expiration date (validation limit) of communication based on the profile.

Furthermore, when the user desires to set (A3) Available area (e.g., country or region), the terminal device 20 displays, on the output unit 25, the window P16 for setting the available area (country or region in FIG. 9) as the end condition. The available area set here is an area in which communication based on the profile is possible. The available area is not limited to the country or the region, and may be, for example, a predetermined area such as an event venue. In addition, the setting example of the available area is not limited to the example illustrated in FIG. 9. For example, with respect to the profile, the terminal device 20 may be configured to set an area in which the communication based on the profile is not allowed (unavailable area). The terminal device 20 can be used outside the unavailable area, and thus the setting of unavailable area can be regarded as one type of setting of the available area.

Note that the end conditions that can be set in the profile are not limited to the above three (A1) to (A3). For example, the terminal device 20 may also be configured to set the following (A4) to (A5) as the end condition.
(A4) Duration of invalid state
(A5) Duration of out-of-area state

A duration of a state in which the profile has not been used is (A4) Duration of invalid state (e.g., from the last use of the profile). Further, a duration after the terminal device 20 enters the out-of-area state is (A5) Duration of out-of-area state.

Note that the terminal device 20 may be configured to be able to set, in the profile, only one end condition or may be configured to be able to set a plurality of end conditions. For example, the terminal device 20 may be configured to be able to set, in the profile, one or more end conditions selected from the above end conditions (A1) to (A5). It is apparent that the terminal device 20 may be configured to be able to set, in the profile, an end condition other than the above (A1) to (A5).

When the setting of the end condition is completed, the terminal device 20 ends the end condition setting process.

Returning to FIG. 6, when the end condition is set in the downloaded profile (Step S102: Yes), the output control unit 233 of the terminal device 20 notifies the user of the end condition set in the profile (Step S105).

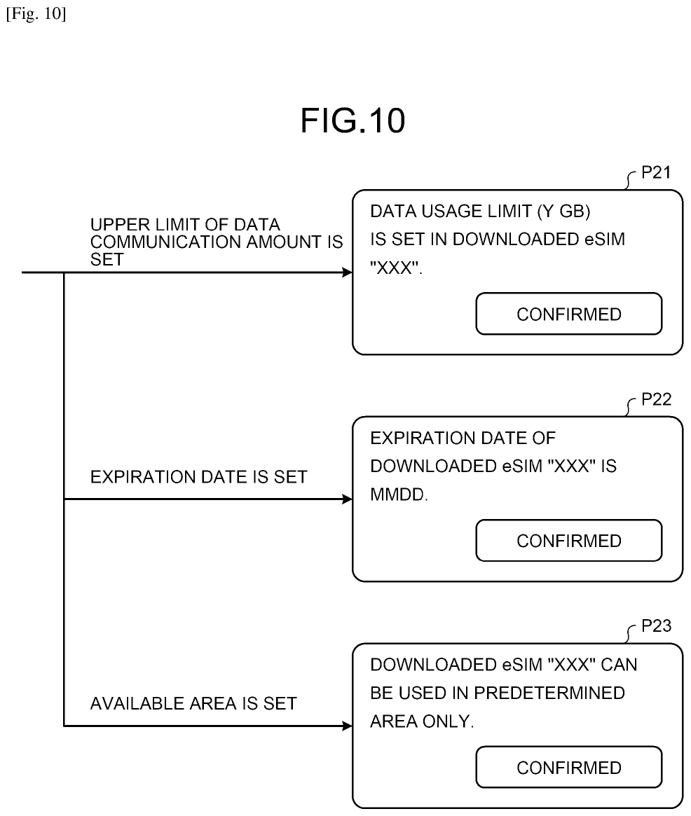

FIG. 10 is a diagram illustrating an example of the user interface for notifying the user of the end condition. In the example in FIG. 10, the terminal device 20 notifies the three conditions (A1) to (A3) as the end conditions. In the drawing, a character string for identifying the downloaded profile is indicated as XXX.

For example, when (A1) Data communication amount is set as the end condition in the profile, the terminal device 20 displays, on the output unit 25, a window P21 for notifying the user of the data communication amount (data usage limit) as the end condition. In the drawing, Y represents a value indicating the data communication amount serving as the end condition.

In addition, when (A2) Expiration date is set as the end condition in the profile, the terminal device 20 displays, on the output unit 25, a window P22 for notifying the user of the expiration date. In the drawing, a value (e.g., date) indicating the expiration date is displayed as MMDD.

Further, when (A3) Available area is set as the end condition in the profile, the terminal device 20 displays, on the output unit 25, a window P23 for notifying the user of the available area. In the drawing, a character string (e.g., character string indicating country or region.) indicating the available area is displayed as a “predetermined area”.

Note that the end conditions to be notified to the user are not limited to the three conditions (A1) to (A3) described above. For example, the terminal device 20 may also be configured to set the above (A4) to (A5). Note that the terminal device 20 may be configured to display all of a plurality of end conditions set when the plurality of end conditions is set in the profile.

When the notification of the end condition is completed, the terminal device 20 ends the end condition setting process.

### <3-2. Profile Management Process>

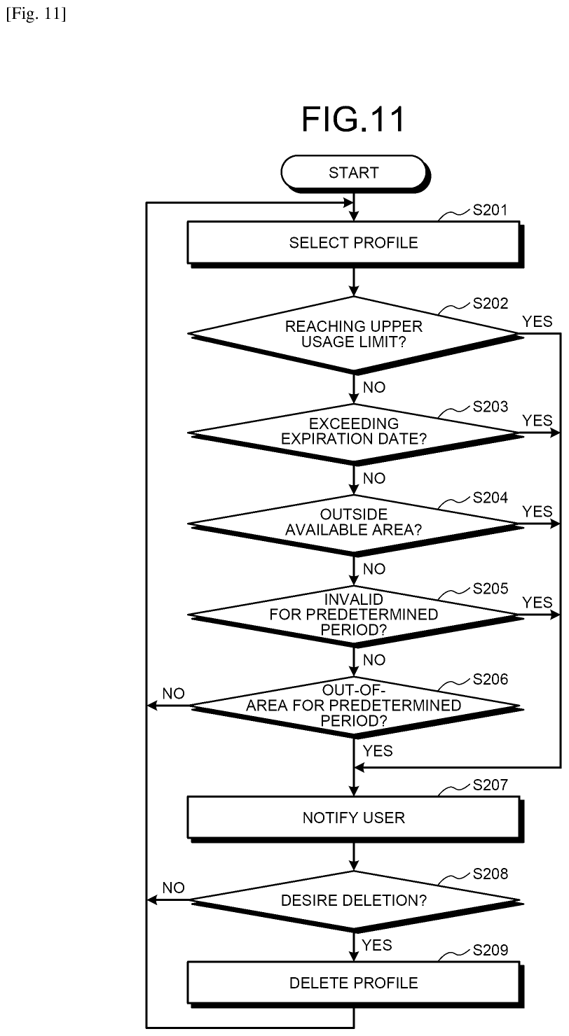

Next, the profile management process will be described. The profile management process is a process for managing the profile. In the profile management process, when the end condition of the use of the profile is satisfied, the terminal device 20 executes an inquiry about deletion of the profile to the user via the user interface. FIG. 11 is an example of a flowchart illustrating the profile management process. The following process is executed, for example, by the control unit 23 of the terminal device 20. Hereinafter, the profile management process will be described with reference to the flowchart in FIG. 11.

The acquisition unit 231 of the terminal device 20 selects one profile recorded in the storage unit 21 (e.g., memory in eUICC) (Step S201). Then, the determination unit 235 of the terminal device 20 determines whether or not the selected profile satisfies the end condition of the use. The end condition may include the following (B1) to (B5). The following (B1) to (B5) correspond to (A1) to (A5) indicated in the end condition setting process, respectively.
(B1) Reaching the data usage limit set in the profile
(B2) Reaching the expiration date set in the profile
(B3) Exiting the available area set in the profile
(B4) Continuing the invalid state of the profile (unused state) for a predetermined period
(B5) Continuing the out-of-area state of the terminal device 20 for a predetermined period

Only one end condition may be set in the profile, or the plurality of end conditions may be set in the profile. For example, one or more end conditions selected from the above end conditions (B1) to (B5) may be set in the profile. It is apparent that an end condition other than the above (B1) to (B5) may be set in the profile.

When one or more end conditions selected from the end conditions (B1) to (B5) are set in the profile, the terminal device 20 may operate as follows.

For example, the determination unit 235 of the terminal device 20 determines whether an amount of communication based on the profile has reached the data usage limit (upper usage limit) set in the profile (Step S202). When the upper usage limit has been reached (Step S202: Yes), the terminal device 20 proceeds the process to Step S207.

When the upper usage limit has not been reached (Step S202: No), the determination unit 235 of the terminal device 20 determines whether the expiration date set in the profile has been reached (Step S203). When the expiration date has been reached (Step S203: Yes), the terminal device 20 proceeds the process to Step S207.

When the expiration date has not been reached (Step S203: No), the determination unit 235 of the terminal device 20 determines whether the terminal device 20 is outside the available area set in the profile (Step S204). When the user is outside the available area (Step S204: Yes), the terminal device 20 proceeds the process to Step S207.

When the user has not left the available area (Step S204: No), the determination unit 235 of the terminal device 20 determines whether the invalid state of the profile (the state in which the profile is not used) has continued for the predetermined period (Step S205). When the invalid state continues for the predetermined period (Step S205: Yes), the terminal device 20 proceeds the process to Step S207.

When the invalid state has not continued for the predetermined period (Step S205: No), the determination unit 235 of the terminal device 20 determines whether the out-of-area state of the terminal device 20 has continued for the predetermined period (Step S205). At this point, even when the profile is valid, the determination unit 235 determines that the end condition is satisfied when the out-of-area state of the terminal device 20 continues for the predetermined period. When the out-of-area state continues for the predetermined period (Step S206: Yes), the terminal device 20 proceeds the process to Step S207.

When the out-of-area state has not continued for the predetermined period (Step S206: No), the terminal device 20 returns the process to Step S201, replaces the profile with another profile, and repeats the process from Step S201.

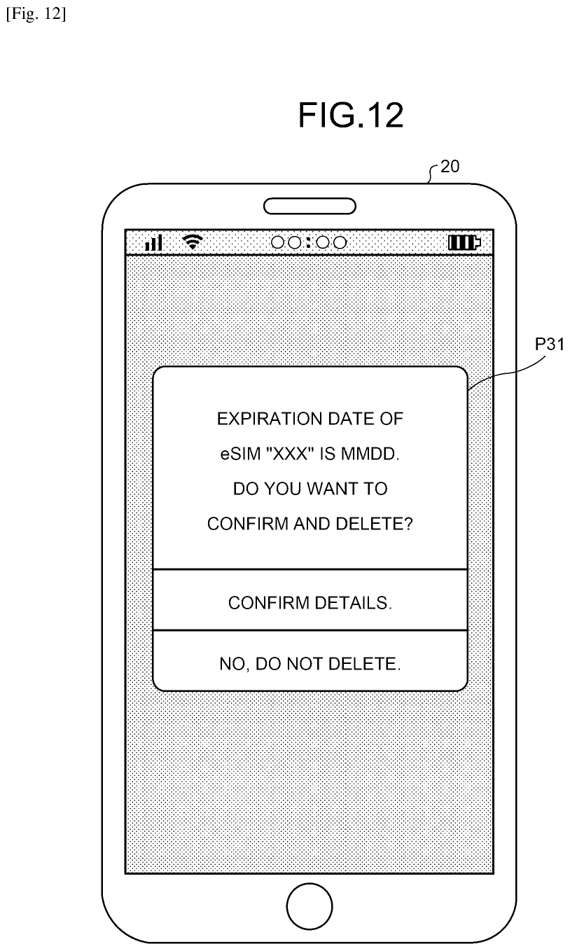

When the selected profile satisfies the end condition of the use (Step S202 to Step S206: Yes), the output control unit 233 of the terminal device 20 executes the inquiry about deletion of the profile to the user via the user interface (Step S207). FIG. 12 is a diagram illustrating an example of the user interface for inquiring about deletion of the profile to the user. Specifically, FIG. 12 is a diagram illustrating a state of inquiring of the user whether to delete the profile when the profile has reached the expiration date. In an example in FIG. 12, the terminal device 20 displays, on the output unit 25, a window P31 for inquiring about whether to confirm the profile to delete the profile.

Note that the user interface does not necessarily need to inquire about confirmation of the profile before deletion. For example, the user interface may simply inquire about whether to delete the profile.

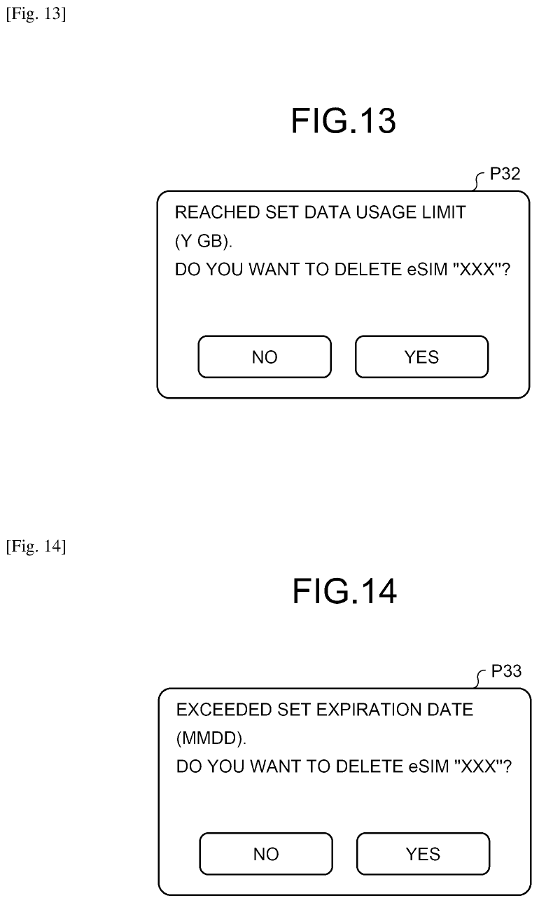

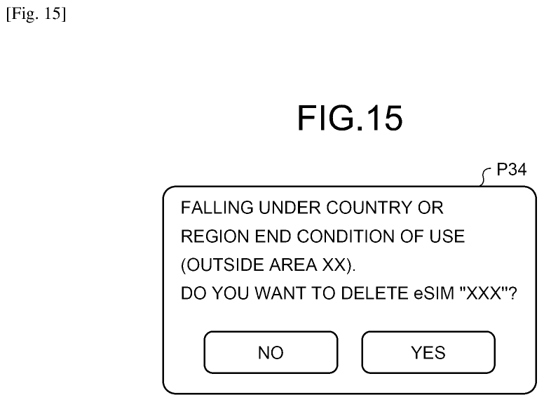

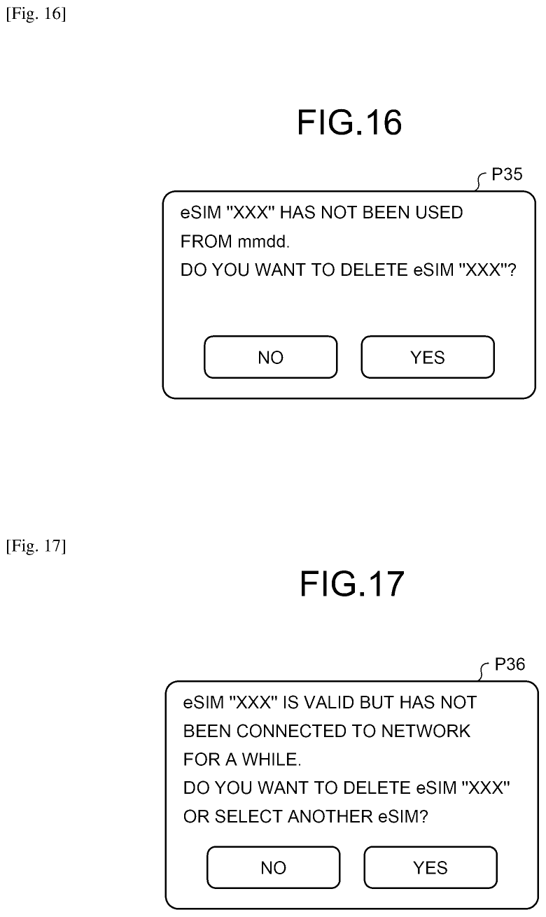

FIGS. 13 to 17 are diagrams illustrating other examples of the user interface for inquiring of the user about deletion of the profile. More specifically, FIG. 13 is a diagram illustrating an example (window P32) of the user interface inquiring of the user whether to delete the profile when the amount of communication based on the profile has reached the upper usage limit. Furthermore, FIG. 14 is a diagram illustrating an example of the user interface (window P33) inquiring of the user whether to delete the profile when the profile has reached the expiration date. Furthermore, FIG. 15 is a diagram illustrating an example (window P34) of the user interface inquiring of the user whether to delete the profile when the terminal device 20 is outside the available area (country or region). Furthermore, FIG. 16 is a diagram illustrating an example of the user interface (window P35) inquiring of the user whether to delete the profile when the invalid state of the profile is continuing for the predetermined period. Furthermore, FIG. 17 is a diagram illustrating an example of the user interface (window P36) inquiring of the user whether or not to delete the profile (or whether to switch to another profile) when the out-of-area state of the terminal device 20 has continued for the predetermined period.

Returning to FIG. 11, the determination unit 235 of the terminal device 20 determines whether the user desires to delete the profile (Step S208). When the user does not desire deletion (Step S208: No), the terminal device 20 returns the process to Step S201, replaces the profile with another profile, and repeats the process from Step S201.

On the other hand, when the user desires deletion (Step S208: Yes), the recording control unit 234 of the terminal device 20 deletes the profile selected in Step S201 from the storage unit 21 (e.g., memory in eUICC) (Step S209).

When the deletion of the profile is completed, the terminal device 20 returns the process to Step S201, replaces the profile with another profile, and repeats the process from Step S201.

### <3-3. Supplement>

### <3-3-1. Profile Metadata>

Profile metadata is associated with the profile. The profile metadata is information regarding the profile used for the purpose of local profile management. Profile metadata requirements are described in Table 21 of NPL 1 (SGP.21 V2.4).

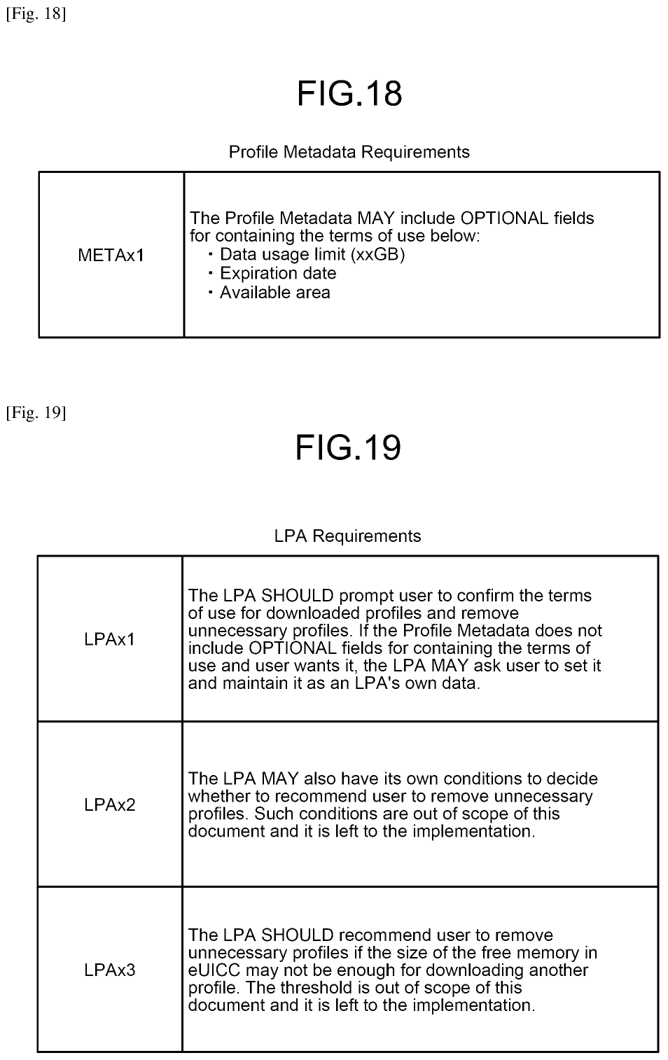

As described above, in the present embodiment, the end condition of the use is set in the profile. In order to include the information on the end condition in the profile, requirements illustrated in METAx1 in FIG. 18 may be added as the profile metadata requirements. FIG. 18 is a table illustrating profile metadata requirements to be added. An appropriate number replaces x1 in METAx1. Requirements described in METAx1 are as follows.

### (METAx1)

The profile metadata may include optional fields for containing the terms of use below.
1. Data usage limit (xxGB)
2. Expiration date
3. Available area

### <3-3-2. LPA>

As described above, the terminal device 20 is provided with the LPA as a functional element (software) for the local profile management. In Table 27 of NPL 1 (SGP.21 V2.4), LPA requirements are described.

In order to realize the terminal device 20 of the present embodiment, requirements illustrated in LPAx1 to LPAx3 in FIG. 19 may be added as the LPA requirements. FIG. 19 is a table illustrating LPA requirements to be added. Appropriate numbers replace respective x1 to x3 in LPAx1 to LPAx3. At least one of LPAx1 to LPAx3 may be applied to the operation of the terminal device 20 of the present embodiment. Requirements described in LPAx1 to LPAx3 are as follows.

### (LPAx1)

The LPA should prompt the user to confirm the terms of use for downloaded profiles and remove unnecessary profiles. If the profile metadata does not include optional fields for containing the terms of use and user wants it, the LPA may ask the user to set it and maintain it as LPA's own data.

### (LPAx2)

The LPA may also have its own conditions to decide whether to recommend the user to remove unnecessary profiles. Such conditions are out of scope of this document and it is left to the implementation.

### (LPAx3)

The LPA should recommend the user to remove unnecessary profiles if the size of the free memory in eUICC may not be enough for downloading another profile. The threshold is out of scope of this document and it is left to the implementation.

### <<4. Modifications>>

The above-described embodiments are examples, and various modifications and applications are possible.

### <4-1. Modification Regarding End Condition of Use>

In <3-2. Profile management process> described above, the following five conditions (B1) to (B5) are given as examples of the end condition of the use of the profile.
(B1) Reaching the data usage limit set in the profile
(B2) Reaching the expiration date set in the profile
(B3) Exiting the available area set in the profile
(B4) Continuing the invalid state of the profile (unused state) for a predetermined period
(B5) Continuing the out-of-area state of the terminal device 20 for a predetermined period

However, the end conditions are not limited thereto, and for example, a condition shown in (B6) below may be included.
(B6) Exceeding a predetermined usage limit (predetermined ratio) of the memory for storing the profile

The end condition may also be a combination of a plurality of conditions. For example, the end condition may be a combination of a plurality of conditions selected from the above (B1) to (B6). For example, the determination unit 235 of the terminal device 20 may determine that the end condition is satisfied when (B6) Exceeding a predetermined usage limit of memory and (B4) Continuing unused state of the profile for the predetermined period. It is possible to prompt the user to manage the profile at a timing when a remaining amount of the memory becomes small.

### <4-2. Modification Regarding Deletion of Profile>

In the above-described <3-2. Profile management process>, when the end condition set in the profile is satisfied, the terminal device 20 inquires of the user whether or not to delete the profile via the user interface (e.g., FIGS. 12 to 17). However, the terminal device 20 may be configured to automatically delete the profile when the end condition set in the profile is satisfied.

In this case, when the profile is downloaded, the terminal device 20 may receive agreement of the user in advance that the profile is automatically deleted when a specific condition is satisfied. For example, when the profile is downloaded, the output control unit 233 of the terminal device 20 inquires of the user, via the user interface, whether to automatically delete the profile in a case where the end condition set in the profile is satisfied. When the user selects to automatically delete the profile and the end condition set in the profile is satisfied, the recording control unit 234 of the terminal device 20 automatically deletes the profile without inquiring of the user.

This can further facilitate the profile management.

### <4-3. Other Modifications>

A control device that controls the server 10 and the terminal device 20 of the present embodiment may be realized by a dedicated computer system or may be realized by a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processes are executed to configure the control device. Here, the control device may be a device (e.g., personal computer) outside the server 10 and the terminal device 20. Furthermore, the control device may be a device (e.g., control unit 13 and control unit 23) inside the server 10 and the terminal device 20.

In addition, the communication program may be stored in a disk device included in the server on the network such as the Internet so that the communication program can be downloaded to a computer. In addition, the above-described functions may be realized by cooperation of an operating system (OS) and application software. In this case, a portion other than the OS may be stored in a medium and distributed, or a portion other than the OS may be stored in the server and downloaded to the computer.

Among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the above document and the drawings can be arbitrarily changed unless otherwise specified. For example, various types of information illustrated in each drawing are not limited to the illustrated information.

In addition, each component of each device illustrated in the drawings is functionally conceptual, and is not necessarily physically configured as illustrated in the drawings. In other words, a specific form of distribution and integration of each device is not limited to the illustrated form, and all or a part thereof can be functionally or physically distributed and integrated in an arbitrary unit according to various loads, usage conditions, and the like. Note that this configuration by distribution and integration may be performed dynamically.

In addition, the above-described embodiments can be appropriately combined in a region in which the processing contents do not contradict each other. Furthermore, the order of each step illustrated in the flowchart of the above-described embodiments can be appropriately changed.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to a unit, or the like (i.e., configuration of a part of device).

Note that, in the present embodiment, the system means a set of a plurality of components (devices, modules (parts), etc.), and it does not matter whether or not all the components are in the same housing. Therefore, a plurality of devices housed in separate housings and connected via a network and one device in which a plurality of modules is housed in one housing are both systems.

Furthermore, for example, the present embodiment can adopt a configuration of cloud computing in which one function is shared and processed by a plurality of devices in cooperation via a network.

### <<5. Conclusion>>

As described above, according to the embodiment of the present disclosure, the terminal device 20 has a function related to storage and deletion of the profile regarding the wireless communication. For example, the terminal device 20 includes the LPA for managing the eSIM profile. The plurality of profiles can be recorded in the terminal device 20. The terminal device 20 is configured to determine whether or not the end condition of the use of the profile is satisfied. When it is determined that the end condition is satisfied, the terminal device 20 executes the inquiry about deletion of the profile to the user via the user interface. When a response indicating the deletion of the profile is acquired from the user, the terminal device 20 deletes the profile.

As a result, the profile management becomes easy, and the convenience of the terminal device 20 is improved. For example, by giving the user an opportunity to delete the profile that is not valid or is not used effectively, it is possible to prompt the user to transfer the profile to another eSIM-compatible device or cancel an unnecessary profile. In addition, it is possible to increase the size of free memory in the eUICC by giving the user an opportunity to delete the profile that is not valid or not used effectively.

Although the embodiments of the present disclosure have been described above, the technical scope of the present disclosure is not limited to the above-described embodiments as it is, and various modifications can be made without departing from the gist of the present disclosure. In addition, the components of different embodiments and modifications may be appropriately combined.

Note that the effects of each embodiment described in the present specification are merely examples and not limited thereto, and other effects may be provided.

The present technology can also have the following configuration.

(1)

A communication apparatus having a function related to storage and deletion of a profile regarding wireless communication, the communication apparatus comprising:
a determination unit configured to determine whether or not an end condition of use of the profile is satisfied; and
an output control unit configured to execute an inquiry about deletion of the profile via a user interface when the end condition is satisfied.
   (2)

The communication apparatus according to (1), wherein
the communication apparatus has a function of recording a plurality of profiles in a memory.
   (3)

The communication apparatus according to (1) or (2), wherein
the end condition includes reaching a data usage limit set in the profile.
   (4)

The communication apparatus according to any one of (1) to (3), wherein
the end condition includes reaching an expiration date set in the profile.
   (5)

The communication apparatus according to any one of (1) to (4), wherein
the end condition includes exiting an available area set in the profile.
   (6)

The communication apparatus according to any one of (1) to (5), wherein
the end condition includes continuation of an invalid state of the profile for a predetermined period.
   (7)

The communication apparatus according to any one of (1) to (6), wherein
the communication apparatus has a function of recording a plurality of profiles in a memory,
the end condition includes continuation of a state of not using the profile for a predetermined period, and
the determination unit determines that the end condition is satisfied when exceeding a predetermined usage limit of the memory and the state of not using the profile continues for the predetermined period.
   (8)

The communication apparatus according to any one of (1) to (7), wherein
the end condition includes continuation of an out-of-area state of the communication apparatus for a predetermined period, and
the determination unit determines that the end condition is satisfied, even when the profile is valid, when the out-of-area state of the communication apparatus continues for the predetermined period.
   (9)

The communication apparatus according to any one of (1) to (8), further comprising
a setting unit configured to set the end condition in the profile when the end condition is not set in the profile.
   (10)

The communication apparatus according to (9), wherein
the output control unit executes an inquiry about setting of the end condition in the profile via the user interface when the end condition is not set in the profile, and
the setting unit sets the end condition in the profile according to a response of a user to the inquiry about the setting of the end condition.
   (11)

The communication apparatus according to any one of (1) to (10), further comprising
a recording control unit configured to delete the profile according to a response of a user to the inquiry about the deletion of the profile.
   (12)

The communication apparatus according to (11), wherein
the output control unit inquires of the user, via the user interface, whether to automatically delete the profile when the end condition set in the profile is satisfied, and
the recording control unit automatically deletes the profile without inquiring of the user when automatic deletion of the profile is selected and the end condition set in the profile is satisfied.
   (13)

The communication apparatus according to any one of (1) to (12), wherein
the profile is an eSIM profile.
   (14)

The communication apparatus according to any one of (1) to (13), wherein
the communication apparatus is a smartphone.
   (15)

A communication method executed by a communication apparatus having a function related to recording and deletion of a profile regarding wireless communication, the communication method comprising:
determining whether or not an end condition of use of the profile is satisfied; and
executing an inquiry about deletion of the profile via a user interface when the end condition is satisfied.

### (1A)

A communication apparatus, comprising:
circuitry configured to
   determine whether an end condition is satisfied, the end condition relating to an embedded subscriber identity module (eSIM) profile stored in a memory; and
   in a case that the end condition is satisfied, control display of an output via a user interface, the output requesting instruction whether or not to delete the eSIM profile.

### (2A)

The communication apparatus according to (1A), wherein the end condition is indicated in the eSIM profile.

### (3A)

The communication apparatus according to (1A), wherein
the end condition is a data usage limit, and
the circuitry determines that the end condition is satisfied when data usage by the communication apparatus using the eSIM profile has reached the data usage limit.

### (4A)

The communication apparatus according to (1A), wherein
the end condition is an expiration date, and
the circuitry determines that the end condition is satisfied when the expiration date has been reached.

### (5A)

The communication apparatus according to (1A), wherein
the end condition is an available area, and
the circuitry determines that the end condition is satisfied when the communication device is no longer in the available area.

### (6A)

The communication apparatus according to (1A), wherein
the end condition is an invalid state, and
the circuitry determines that the end condition is satisfied when the eSIM profile is in the invalid state for a predetermined period of time.

### (7A)

The communication apparatus according to (6A), wherein
the invalid state is an unused state, and
the end condition is satisfied when the eSIM profile is in the unused state for the predetermined period of time.

### (8A)

The communication apparatus according to (1A), wherein
the end condition is an out-of-area state, and
the circuitry determines that the end condition is satisfied when the communication device is in the out-of-area state for a predetermined period of time.

### (9A)

The communication apparatus according to (8A), wherein the circuitry determines that the communication apparatus is in the out-of-area state when the communication apparatus using the eSIM profile has not connected to the service network for the predetermined period of time.

### (10A)

The communication apparatus according to (1A), wherein the circuitry is further configured to
receive the instruction via the user interface, and
in a case that the instruction indicates to delete the eSIM profile, delete the eSIM profile from the memory.

### (11A)

The communication apparatus according to (1A), wherein the circuitry is further configured to set the end condition of the eSIM profile according to an input via the user interface.

### (12A)

The communication apparatus according to (1A), wherein the circuitry is further configured to
control display of plural end condition as options for selection via the user interface, and
receive selection of a particular end condition via the user interface.

### (13A)

The communication apparatus according to (12A), wherein the circuitry is further configured to set particular end condition as the end condition of the eSIM profile.

### (14A)

The communication apparatus according to (1A), wherein
the end condition includes a first condition and a second condition, and
the circuitry is configured to determine whether one or more of the first condition and the second condition is satisfied.

### (15A)

The communication apparatus according to (1A), wherein the output further indicates details of the end condition.

### (16A)

The communication apparatus according to (1A), further comprising the memory which stores the eSIM profile.

### (17A)

A communication method, comprising:
determining, by circuitry of a communication apparatus, whether an end condition is satisfied, the end condition relating to an embedded subscriber identity module (eSIM) profile stored in a memory; and
in a case that the end condition is satisfied, displaying an output via a user interface, the output requesting instruction whether or not to delete the eSIM profile.

### (18A)

The communication method according to (17A), wherein the end condition is indicated in the eSIM profile.

### (19A)

The communication method according to (17A), further comprising:
receiving the instruction via the user interface; and
in a case that the instruction indicates to delete the eSIM profile, deleting the eSIM profile from the memory.

### (20A)

A non-transitory computer readable medium storing computer executable instructions which, when executed by circuitry of a communication apparatus, cause the communication apparatus to:
determine whether an end condition is satisfied, the end condition relating to an embedded subscriber identity module (eSIM) profile stored in a memory; and
in a case that the end condition is satisfied, control display of an output via a user interface, the output requesting instruction whether or not to delete the eSIM profile.

### REFERENCE SIGNS LIST

1 Communication system
10 Server
20 Terminal device
11, 21 Storage unit
12, 22 Communication unit
13, 23 Control unit
24 Input unit
25 Output unit
231 Acquisition unit
232 Setting unit
233 Output control unit
234 Recording control unit
235 Determination unit
N1, N2 Network

1. A communication apparatus, comprising:
circuitry configured to
determine whether an end condition is satisfied, the end condition relating to an embedded subscriber identity module (eSIM) profile stored in a memory; and
in a case that the end condition is satisfied, control display of an output via a user interface, the output requesting instruction whether or not to delete the eSIM profile.

2. The communication apparatus according to claim 1, wherein the end condition is indicated in the eSIM profile.

3. The communication apparatus according to claim 1, wherein
the end condition is a data usage limit, and
the circuitry determines that the end condition is satisfied when data usage by the communication apparatus using the eSIM profile has reached the data usage limit.

4. The communication apparatus according to claim 1, wherein
the end condition is an expiration date, and
the circuitry determines that the end condition is satisfied when the expiration date has been reached.

5. The communication apparatus according to claim 1, wherein
the end condition is an available area, and
the circuitry determines that the end condition is satisfied when the communication device is no longer in the available area.

6. The communication apparatus according to claim 1, wherein
the end condition is an invalid state, and
the circuitry determines that the end condition is satisfied when the eSIM profile is in the invalid state for a predetermined period of time.

7. The communication apparatus according to claim 6, wherein
the invalid state is an unused state, and
the end condition is satisfied when the eSIM profile is in the unused state for the predetermined period of time.

8. The communication apparatus according to claim 1, wherein
the end condition is an out-of-area state, and
the circuitry determines that the end condition is satisfied when the communication device is in the out-of-area state for a predetermined period of time.

9. The communication apparatus according to claim 8, wherein the circuitry determines that the communication apparatus is in the out-of-area state when the communication apparatus using the eSIM profile has not connected to the service network for the predetermined period of time.

10. The communication apparatus according to claim 1, wherein the circuitry is further configured to
receive the instruction via the user interface, and
in a case that the instruction indicates to delete the eSIM profile, delete the eSIM profile from the memory.

11. The communication apparatus according to claim 1, wherein the circuitry is further configured to set the end condition of the eSIM profile according to an input via the user interface.

12. The communication apparatus according to claim 1, wherein the circuitry is further configured to
control display of plural end condition as options for selection via the user interface, and
receive selection of a particular end condition via the user interface.

13. The communication apparatus according to claim 12, wherein the circuitry is further configured to set particular end condition as the end condition of the eSIM profile.

14. The communication apparatus according to claim 1, wherein
the end condition includes a first condition and a second condition, and
the circuitry is configured to determine whether one or more of the first condition and the second condition is satisfied.

15. The communication apparatus according to claim 1, wherein the output further indicates details of the end condition.

16. The communication apparatus according to claim 1, further comprising the memory which stores the eSIM profile.

17. A communication method, comprising:
determining, by circuitry of a communication apparatus, whether an end condition is satisfied, the end condition relating to an embedded subscriber identity module (eSIM) profile stored in a memory; and
in a case that the end condition is satisfied, displaying an output via a user interface, the output requesting instruction whether or not to delete the eSIM profile.

18. The communication method according to claim 17, wherein the end condition is indicated in the eSIM profile.

19. The communication method according to claim 17, further comprising:
receiving the instruction via the user interface; and
in a case that the instruction indicates to delete the eSIM profile, deleting the eSIM profile from the memory.

20. A non-transitory computer readable medium storing computer executable instructions which, when executed by circuitry of a communication apparatus, cause the communication apparatus to:
determine whether an end condition is satisfied, the end condition relating to an embedded subscriber identity module (eSIM) profile stored in a memory; and
in a case that the end condition is satisfied, control display of an output via a user interface, the output requesting instruction whether or not to delete the eSIM profile.
